(19) United States
(12) Patent Application Publication
(10) Pub. No.: US 2008/0228553 A1
(43) Pub. Date: Sep. 18, 2008

(54) Method And System For Determination Of An Appropriate Strategy For Supply Of Renewal Energy Onto A Power Grid

(75) Inventors: Alexander Bryson, Capel Street (IE); Ronan Doherty, Portnoo (IE); Khilna M. Dodhia, (US); Brian Hurley, Skerries (IE); Peter Carty, Leixlip (IE)

Correspondence Address: NEAL, GERBER, & EISENBERG, SUITE 2200, 2 NORTH LASALLE STREET, CHICAGO, IL, 60602, US

(73) Assignee: Airtricity Holdings Limited, Glasthule (IE)

(21) Appl. No.: 11/685,015

(22) Filed: Mar. 12, 2007

(51) Int. Cl. G06F 17/30; G06F 12/00

(52) U.S. Cl. 705/10; 711/100

(57) ABSTRACT

A system and methodology for determining optimal sales strategy for power from a wind farm to a power grid for a number of different conditions is disclosed. By defining distributions for the forecast for the output of the wind farm and combining that with a forecast for market conditions it is possible to evaluate optimum values for the volume of power that can be contributed by the wind farm for specific time periods.

### FIELD OF THE INVENTION

The present invention relates to power grids, particularly electricity power grids. The invention more particularly relates to such power grids that include a plurality of different sources for the total power provided by the grid. In particular the invention relates to a method and system that provides for a determination of an appropriate strategy for power provided to the grid by a variable renewable source, desirably wind power. Such a strategy may be utilized in a sales or trading environment to determine the sales volume of the renewable energy that may be contributed onto the power grid.

### BACKGROUND

Within the context of power grids it is known to provide the overall available power from a plurality of different sources. Traditionally these would have been based on a variety of carbon based energy sources such as coal or oil or gas fuelled power facilities. Other sources include nuclear power. In recent times there have been attempts to increase the ratio of power that is provided to the power grid from renewable resources such as wave or wind power. While being a clean, environmentally friendly source of power, such renewable sources are dependent on weather conditions and it is necessary to accurately forecast the volume of power that will be input into or onto the grid from such sources in any one time period. In effect the wind output from any one wind generating site is a stochastic variable. This variability makes sales of volume under the traditional commodity trading model (firm contracts from the producer to another party) difficult and risky. Within this context it will be understood that where terms such as “accurately” are used that it is intended that these be interpreted within a statistical context as being accurate within a predetermined tolerance level of variance.

Solutions to this problem are based upon the providers of such power entering into short term contracts with the grid operator or other third parties as to their expected contribution over a specific time period. This time period may vary depending on the specifics of the geography. In Ireland for example, the contract period is normally over a time period of 24 hours in advance. Such time periods are at the upper limit of what can be reasonably meteorologically forecasted. As the grid consumption is a relatively determinable factor it is important that any promised contribution is provided, as if there is a shortfall in the ability of the renewable energy provider to provide this contracted energy, such shortfall must be met from other sources.

To ensure that the renewable energy provider provides a realistic contracted amount to the grid, there may be penalty clauses associated with the contract or in the structure of the market. If a provider contracts to provide a certain volume of power, then failure to provide that power will likely result in the provider being obliged to pay a penalty based on the shortfall. There is therefore a disincentive to wind energy suppliers to over promise. Further discussion about the use of wind energy as a contributor to an overall energy grid is provided in International Patent Application WO02054561 which discusses the supplementing of the wind contribution with power from other sources.

However, for the providers of wind energy to a power grid there is a desire for the provider to obtain the best possible return on their facility. They need to ensure that the contribution that they provide is provided at the best possible return for the investment. This may be based on ensuring that the power generated at specific wind farms may be distributed into the grid at the optimum level with regard to price, risk and confidence. There is therefore a need to enable a wind power operator to assess the optimum volume of power that they can sell firmly to a power grid over a specific time period.

### SUMMARY

These and other problems are addressed by a system and methodology in accordance with the teaching of the invention. Such a system enables an operator of variable renewable generation facilities to determine the optimum volume of energy that they can sell firm in a determinable time period. Using the teaching of the invention it is possible to combine the expected output from the renewable power facility with market price projections to determine the optimum amount that should be sold by the operator. The amount can be optimized for a number of different values including best price, least risk and other parameters that will become evident from the following discussion.

Using the teaching of the invention it is possible to identify what portion of the output of a renewable energy source such as a wind farm may be determined within a first degree of accuracy so as to enable the renewable energy provider to sell that portion of the output as a firm output volume for which the operator is reasonably satisfied will be met. In this context the term “sell firm” or “firm sell” is intended to define a quantity or volume which meets a first degree of accuracy as to ability to provide. The system and methodologies of the invention also provide for an identification of a second portion of the output as being determinable within a second degree of accuracy so as to enable the operator to spill or nominate that portion as being a non-firm portion. Within this context the “non-firm” portion represent a quantity or volume that meets a second degree of accuracy as to ability to provide. It will be appreciated that the first degree of accuracy represents a more confident statistical prediction than the second degree of accuracy. Within this teaching it is possible to maximize the portion that can be offered as a firm commitment and minimize the exposure to possible penalties that would ensue should that commitment not being forthcoming. Using the teaching of the invention it is possible to provide a balance between reward and penalty.

Accordingly, a first embodiment of the invention provides a methodology according to claim 1. The invention also provides a system according to claim 12. Advantageous embodiments are provided in the dependent claims thereto. Other embodiments come to mind with references to the claims and the present description.

### BRIEF DESCRIPTION OF THE DRAWINGS

The present invention will now be described with reference to the accompanying drawings in which:

FIG. 1 is a schematic showing a layered computer architecture according to the teaching of one embodiment of the invention.

FIG. 2 shows in schematic form data transfer between components of a system according to the teaching of one embodiment of the invention.

FIG. 3 shows in schematic form data transfer between components of a system according to the teaching of one embodiment of the invention.

FIG. 4 shows in schematic form how distribution forecasts from different sources may be combined to allow an ultimate decision.

FIG. 5 shows in graphical form examples of the type of distribution forecasts that may be utilized.

FIG. 6 shows graphically an example of a data array provided for a sub-period and the identification of the optimized nominated output.

FIG. 7 shows how the optimized nominated output may vary during re-nomination sequences.

FIG. 8 shows how the estimated cost of re-nomination may be used to optimize the nominated value.

### DETAILED DESCRIPTION OF THE DRAWINGS

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

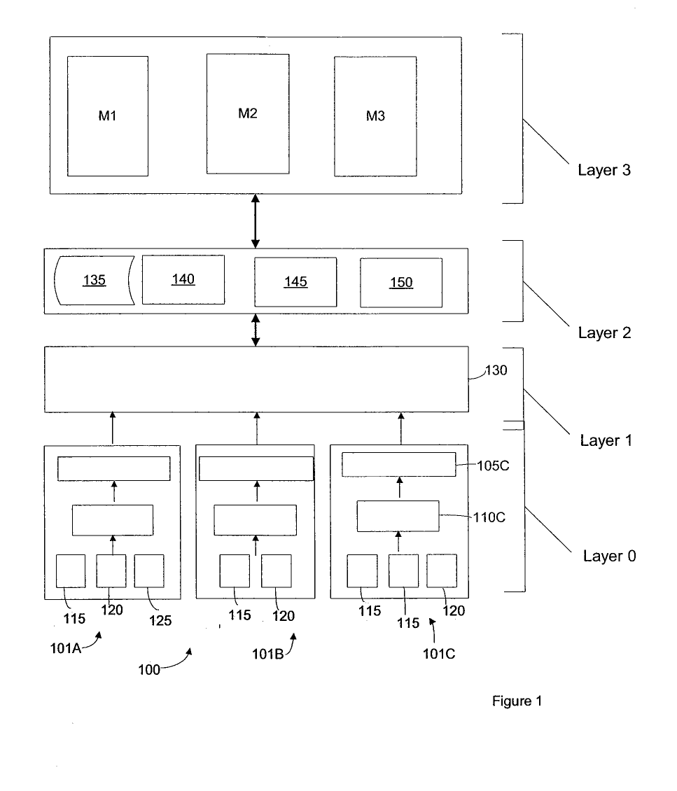

FIG. 1 shows in schematic form a system 100 in accordance with the teaching of one embodiment of the invention. Such a system is useful in collating information from a plurality of different locations 101A, 101B, 101C and operating conditions to provide as an output a forecasted energy quanta that can be provided by a renewable energy provider, such as a wind farm operator, within a prescribed time period.

A system in accordance with the teaching of one embodiment of the invention can be considered as comprising a number of distinct layers. It will be understood that this separation of functionality is provided for ease of understanding and it is possible that functionality or operations that are described with reference to one specific layer be equally be provided within the construct of another layer. The system is illustrated for ease of explanation as including a number of distinct modules or elements but it will be understood by those skilled in the art that such elements or modules may be implemented in one or more hardware or software configurations.

Layer 0: The Physical Layer

The first or base physical layer, layer 0, encompasses the various items of plant or machinery at generation sites which feed operational information into onsite Supervisory Control And Data Acquisition (SCADA) systems.

Original Equipment Manufacturer (OEM) SCADA systems collect real-time telemetry information on generation sites for use by plant operators (current power output would be an example of one such telemetry item). “OEM” is mentioned to indicate that diverse proprietary forms of SCADA system are available as a result of the various manufacturers that provide genset 115, met mast 120 and other equipment for wind farms such as sub-stations 125. One or more of these individual types of equipment may be located at any one site, although of course for a renewable generation facility to operate it is necessary to have at least one genset 115.

The items of the plant within a renewable generation facility that typically generate telemetry data are:
Gensets 115—These are the individual generating units which convert renewable resources to electrical energy. Telemetry items arising from gensets would include power output and fault conditions. Gensets also typically hold equipment that captures real-time meteorological conditions at the turbine. Renewable installations such as windfarms vary in size between a single genset and many dozen which may be provided as a cluster of gensets.
Met Masts 120—These are masts incorporating measuring equipment which capture real time meteorological information at the site location such as wind speed, wind direction, temperature, pressure, humidity and so on. These are free standing structures. It is typical for most wind farms to have at least one Met Mast for each cluster of turbines.

Sub-Station Equipment 125
Transformers—These are grid transformers for converting the voltage from the lower level at which the generation units operate up to the local grid voltage level
Switch Gear—This equipment is used for electrically isolating the site and for protection of the site in the event of faults at the site
Meters—These are meters for measuring electricity produced and consumed by the facility and are part of the SCADA system as opposed to the meters used by the market meter operators to read energy generation

Not all substations generate telemetry information, and not all sites have met masts or SCADA meters. All must by definition contain gensets, however, and these gensets are always linked to SCADA systems. Within the context of wind energy (the most common form of renewable generation) there are many known providers of turbines including those provided by companies such as GE (General Electric), Siemens (incorporating Bonus), Vestas, Nordex, Mitsubishi, Gamesa and others.

The use of different equipment manufacturers results in different SCADA systems operating on different sites. A system in accordance with the teaching of one embodiment of the invention addresses this problem by providing an Energy Management Network (EMN) as a platform to facilitate the convergence of data from different SCADA systems into a single (but distributed—hence “network”) control and information location. (See Layer 1: The Telemetry & Control Abstraction Layer, discussed below)

The connectivity protocols used at the site level to communicate natively with the OEM SCADA will vary according to location and manufacturer. While it is not intended to limit the application of the teaching of one embodiment of the invention to any one protocol typical examples of communication protocols include OPC (Open Protocol Connectivity ) and VMP (Vestas Management Protocol). OPC is an industry attempt to provide a standardized method of accessing SCADA data, but the implementation has tended to be manufacturer-specific with various “flavors” used. VMP on the other hand is a Vestas proprietary protocol. The other differentiator between sites when accessing telemetry from offsite has historically been dial-up via analogue modems and OEM provided software for the interrogation of OEM SCADA systems.

Layer 1: The Telemetry & Control Abstraction Layer

The Telemetry & Control Abstraction Layer includes typical grouping of systems, communications links, interfaces and standardization that permit operational data in a proprietary format at the generation facility to cross the boundary into a centralized Data Centre where it can be accessed in a reasonably standardized format.

Such a system consists of generic SCADA systems 105 situated locally at wind farm sub-station locations which communicate with OEM SCADA systems 110 (see Layer 0). The data retrieved by generic SCADA systems is gathered and communicated to the data centre by means of a variety of communication links such as Satellite or MPLS—Multiple Protocol Label Switching

The data is then aggregated onto central data gatherer servers. An API (Application Program Interface) is exposed by the central systems through which data is passed from this layer to Layer 2: The Universal Forecasting and Trading Layer (see below)

The role of the telemetry control and abstraction layer is therefore to act as a common means of interfacing with physical assets, and it renders direct interaction with OEM SCADA systems redundant. It is designed to be capable of performing any interrogation of, or interaction with, plant items that would otherwise be accomplished by an operator manually dialing in to a site using OEM provided software. In this way the operator can have a single real-time view of the plant situation to inform operating and commercial decisions—the operators can see the aggregated total power output of the portfolio for instance. It will be understood that while such interface may be suitably provided by configurable platforms (such as that offered by Serck Controls) it is not intended to limit the invention to any one specific implementation except as may be deemed necessary in the light of the appended claims.

Layer 2: The Universal Forecasting & Trading Layer

The Universal Forecasting & Trading Layer is defined as that layer of generic processes which do not form part of Layer 1 but nevertheless remain constant regardless of the generating asset that is to be supported. This layer of processes is the foundation on which additional processes are built to support the specific business requirements of the operator—one example being the trading of a wind energy asset.

As mentioned above, the output of facilities such as wind farms is variable and not controllable. There is almost always a commercial incentive to be capable of predicting the generation output of a facility—as a simplistic example consider a number of providers of wind energy who also act as an electricity supply business, and as such a wind farm operator who also provide electricity to end customers must try to predict whether it needs to purchase additional energy for its customers should wind conditions on a particular day be poor. Thus generation forecasting is essential to the purchasing decision, and more generally forecasting is an essential input to trading. In order to correctly analyze the optimum amount of firm sale volume from a specific collation of wind farms a degree of analysis is required as to the current and forecast market conditions and how that correlates with the current and forecast wind condition.

According to the teaching of one embodiment of the invention a number of processing modules may be employed to do various aspects of the necessary processing, and that data that is used for that processing and output from the processing may be stored centrally within Layer 2 as part of a central data repository CDR, 135. Such a CDR provides a secure, shared database for collecting and managing data for the purposes including: Forecasting; Generation Output Forecasting; Analysis; Analysis for day to day operations; and/or, Trading/Dealing.

Such a repository could also be useful in storage of rules, calculations and instructions for handling the various inputs to the process. This information will be stored as stored procedures or functions within the database and referenced as required based on the market arrangements or bilateral contracts in place with counterparties. This allows a high degree of re-use, removes duplication of logic, reduces maintenance and effort as each new asset is added to the system for management.

By providing a central repository which can be implemented within a secure computing environment it is possible to provide for tracing of decisions and operations by user interaction with the CDR. Use of a CDR removes the need for duplication of inputs/outputs, provides multiple reporting tools and interfaces and can be used to reduce the possibility of human error within a processing environment by minimizing the human involvement with the data.

The CDR provides the ability to aggregate all process-centric data in the enterprise from all relevant internal legacy, newer information systems and external data sources to provide maximum data processing flexibility. The centralization of data in the CDR by extension will also ensure data quality

As shown in FIG. 2, inputs to the CDR may include: Market forecast data; Weather forecast data (215); Maintenance data (205); and/or, Loss factors (210).

The interfaces to the CDR, whether reporting tools or applications, will then govern the process by which data is used within the Forecasting and Trading process and reduce the scope for human error. Once the data is centrally deposited a processor module 400 may then interface with the CDR and access the relevant data as required.

It will be understood that while forecasting and trading are two critical functions in the optimized provision of wind energy, it is insufficient to consider these two functions on their own. Predictions of generation output are not only a function of meteorological conditions, but also of availability of generating plant, and hence it is important to provide within the definition of future available power the overall performance of the physical plant that is used to generate the power.

The processes that form the contents of the layer are: Availability Scheduling/Maintenance Forecasting 140, Generation Forecasting Service—individual wind farms 145, Generation Forecast Manipulation 150.

A brief description of the core processes for each of the three functions just enumerated follows: Availability Scheduling 140: Generation output from a renewable generation facility is directly influenced by the proportion of the site (e.g. number of turbines) available at a given time. Theoretically a generation forecast should take the best estimate of future genset availability into account, but in practice this is very difficult to achieve, and would involve the transfer of availability schedules and estimates to a forecast provider before each forecast. In addition, some of these fluctuations in availability may only become known after the publication of forecasts using earlier availability estimates, and hence adjustment of the forecast to take account of the new information would be required in any case.

In accordance with the teaching of one embodiment of the invention, generation forecasts as produced by an external generation forecasting service might assume full future wind farm availability, and that subsequent to the receipt of a generation forecast the operator applies adjustments to account for any missing availability. Alternatively availability forecasts might be transferred to the forecasting service or module. The first operation is schematically illustrated in the arrangement of FIG. 2, where an external interface 200 is provided whereby a system operator may input information such as a turbine maintenance schedule or turbine availability recording and prediction data into a maintenance scheduler or indeed loss characteristics into a loss factor evaluator 215. Such data is then fed to and accessed through the CDR 135. The use of the CDR as a central repository means that the data can be easily access by other applications or process modules. Once a forecast is determined it may be output to a forecast viewer 215 which is then presented to the operator 200 via a graphical user interface or some other suitable interface.

Generation Forecast Service 145 This service module provides information as to the expected renewable generation, and may sometimes be provided by third party suppliers. Short term wind power output forecasting operate typically on horizons of 1 hour up to 168 hours ahead, although it will be appreciated that longer time periods could also be utilized. Forecasts are made for the power output and meteorological conditions of generation facilities. Wind power output forecasting has been in research and development since the 1970s. Its use as a commercial service started in the 1990s. The simplest form of wind power output forecasting is Persistence Forecasting. This model assumes that the power output forecast for all hours ahead will be the power generated at 0 hours.

Many current forecast models combine meteorological forecasts from Numerical Weather Prediction models with onsite meteorological and power output measurements to produce site specific power and meteorological forecasts. There are many different commercial forecasting services available, and within the context of one embodiment of the present invention it is not intended to limit the use of forecasts to those available from any one provider.

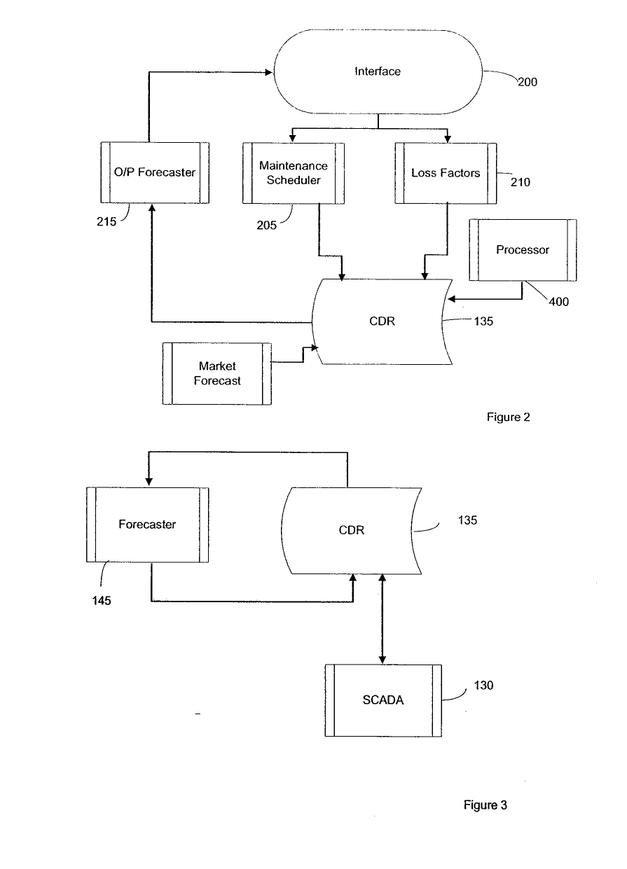

The interaction of SCADA data and the CDR insofar as they relate to forecasting are described by the process flow of FIG. 3. The most accurate wind farm output forecasting combines both meteorological models and real time SCADA data as described above. It is also possible to forecast without live SCADA data, but to a lesser degree of accuracy. Within this context it is desirable to provide the CDR 135 with specifics of the facility operational data such as genset telemetry (e.g. power, availability flags), Met Mast telemetry (e.g. wind speed at 50 m altitude), Substation telemetry (e.g. power exported). As was mentioned above this data is correlated at the SCADA interface 130 where it is accessible by the CDR. Using such live data it is possible to provide same to the third party forecaster 145, so as to improve the accuracy of the data which the forecaster can then return to the CDR.

Such data is desirably forwarded to a forecaster at regular intervals throughout the day—such as for example at 30 minute intervals. These submission intervals may vary according to regulations and market trading requirements of forecasts.

Using such real-time data, the forecaster is able to provide to the CDR site specific meteorological and power production forecasts for a horizon of a predefined and agreed time period ahead. Uncertainty predictions of power output are also provided in each forecast.

Layer 3: Market Specific Layer

Within this layer specifics of the market where the power is to be provided are detailed. In the schematic of FIG. 1, three different market regions M1, M2, M3 are illustrated—each of which may typically vary in specifics of how the power is provided, the alternative power supplies that the wind energy is competing against and other parameters. The components of Layer 2 can interface with these individual markets to obtain the relevant information as appropriate.

Forecasting and Trading

It will be understood from the preceding that a network architecture within the context of one embodiment of the invention may be considered as being formed from a plurality of layers; the plant and machinery necessary to provide the renewable power designated as falling within Layer 0 and the specifics of the market where the power is to be provided within Layer 3. The interface between these two is to be found in Layers 1 and 2, the main processing and data collation being located within Layer 2.

Optimization Engine

Heretofore has been described an architecture useful in an extraction and storage of data associated with the output of one or more renewable generation facilities. While such storage is useful in providing a reporting structure, one embodiment of the invention provides for a use of such data in order to implement an accurate forecasting methodology that provides an optimum return for the operator of the wind farm. To do this, it is necessary for the operator of the renewable generation facility to estimate: i. The output of the facility; ii. The price obtainable in the market for sales or purchases of energy; iii. The price or prices that market participants will face (usually levied by the system operator) should they not match their net contract position with physical generation or demand flows; and thereafter by combining this information the operator can derive an optimum volume to transact in the market (and by the extension the volume of expected energy to leave un-contracted).

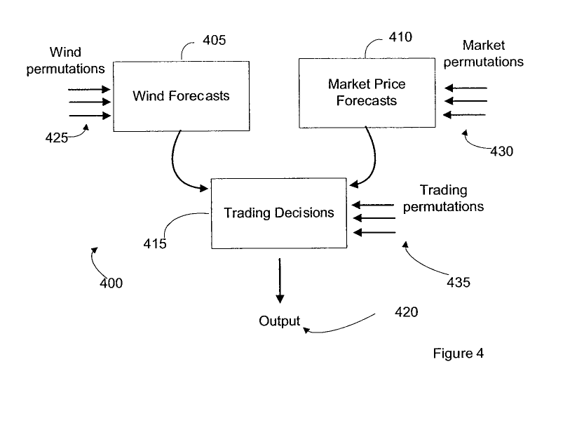

One embodiment of the invention addresses this problem by enabling a combination of wind forecasts and price forecasts to define a trading decision. As shown in FIG. 4 such an arrangement can be used to combine statistical distributions from multiple sources to define an optimum strategy for the operator. The processor or nomination optimization engine 400 is configured to provide as an output an identification of the portion of the wind farm output that the operator wishes to firmly sell, and a portion that the operator wishes to not sell (recognizing that this portion may be physically generated). The operator will expect to receive different prices for the sold and unsold portions. Such first and second prices differ in the fact that they are associated with firm and non-firm volumes of energy; typically the price that is achievable at the firm price is higher than that for the non-firm price in that the buyer will pay more for the confidence of having a firm commitment of a specific volume of energy.

Such a Nomination Optimization Engine 400 processes input data from various sources to provide as an output firm sales amounts, taking account of contract prices, under-generation penalties and generation forecast. By using such an engine it is possible to maximize profits from selling the best amount in every settlement period. It will be understood within the context of the present description that the term “nomination” is intended to represent sales in the open market, or a parameter that may be provided to external third parties or may be used internally for further analysis process.

The engine provides as an output an indication of the optimum quantity of energy that can be sold firmly by the operator. The decision is based on outputs from two sub-modules; a wind forecast module 425 and a market price forecast module 410. Each of these modules provide a statistical output as to the behavior expected over a predefined future time period. These statistical outputs may be considered as having a distribution form or confidence measure as to the expected conditions that they are representing.

As each of the two modules 425, 410 are providing an estimate of the behavior that they are representing, it will be appreciated that the output from each module is dependent on a number of parameters. These parameters which affect the wind forecast and confidence measures of the forecast include meteorological model predictions and wind farm operational data. In this way the forecast output which is indicative of 100% wind farm availability will be tailored based on the actual operating conditions of the sites being forecast. Certain data related to the parameters which affect the wind forecast will desirably be stored within the CDR (see FIG. 1) until the generation forecasting module or service calls on the parameters to effect processing.

In a similar fashion market permutations 430 such as the general expected usage of power over a prescribed future time period or the level of operation of other power sources—such as for example if traditional power stations are experiencing upgrades or undergoing maintenance, will influence market demand and ultimately price. These can also be factored into a distribution with an expected probability of achievement.

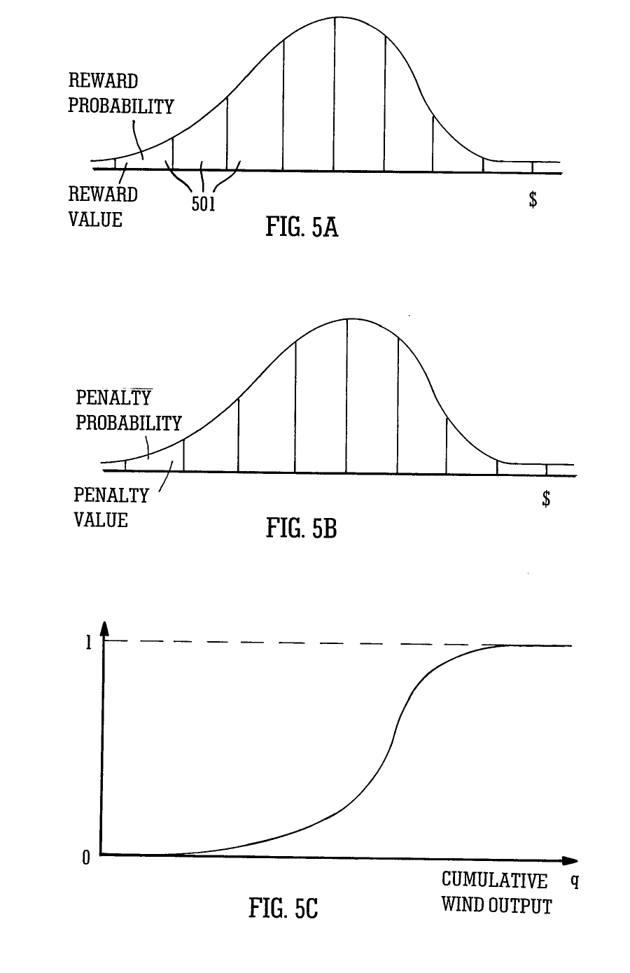

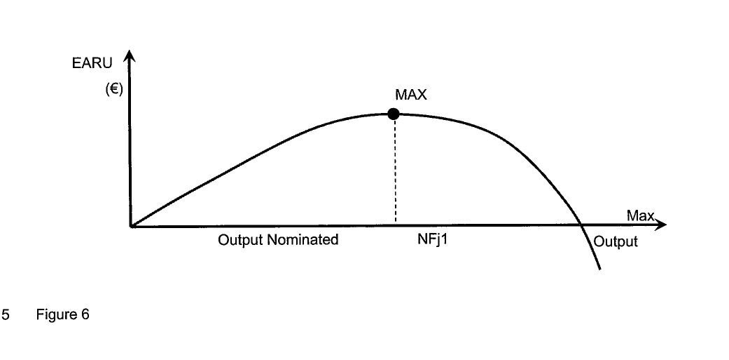

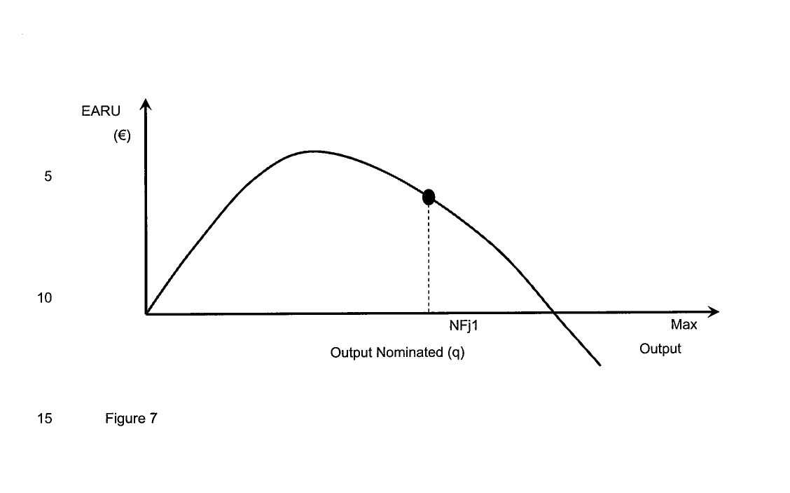

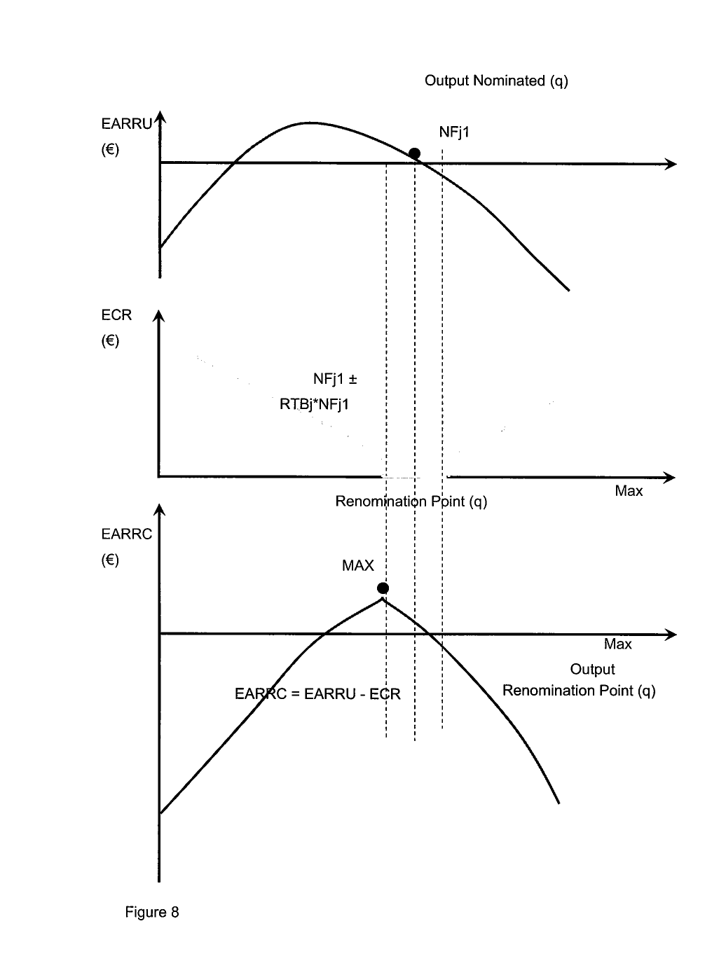

Essentially each of the two sub modules provides an expected output from the wind farm and expected prices for energy. As shown in FIG. 5 the expected prices for energy, i.e. the market forecasts are provided in the form of a distribution forecast with individual bins 501 having an associated probability and value. The reward price is considered to be the increase in unit revenue for selling firm as opposed to spilling, and the penalty price is the price that must be contributed in compensation to the system operator or counterparty for failing to produce energy that has been sold. FIG. 5a shows a probability distribution for a reward price whereas FIG. 5b shows an equivalent distribution for a penalty price. It will be understood that each of the bins shown in the distribution profiles of FIG. 5 have a probability and value pairing, be that for reward or penalty. In the context of the generation forecast this may be provided as a standard distribution forecast or as shown in FIG. 5c as a cumulative distribution. The mating of the reward probability parings with the wind output will determine the price achievable for certain volumes. However there are still certain trading conditions or permutations 435 which will affect how the two are combined. For example, if there is a certain penalty associated with promising a certain level of power, if that power level is not provided—then the operator may decide to operate a risk-averse trading strategy and be conservative in the contracted amount of energy being supplied. Using computational techniques that implement one or more algorithm functions it is possible to determine the point on the “EARU” function (see below) that best matches the objective of the renewable generator. Alternatively the profit possible on providing a certain volume may significantly outweigh the penalty in that amount not being supplied so a higher volume may be contracted. Therefore it is useful to include the contribution that the penalty price parings will have on the output.

It is typical within context of power trading for the maximum market liquidity to occur around 24 hours from delivery, although power may be contracted many months in advance, and sometimes very shortly before it is delivered. By selling output the renewable facility operator contracts to provide a specific amount of energy in a specific period (or periods) at a specific price. It is also typical for further transactions to occur subsequent to the initial transaction such that the net position of the seller is modified. Such further refinements are important for variable renewable generators since the forecast period is closer to the actual delivery period and is likely to be more accurate. Any sales span is split into specific sub-periods which may be termed settlement periods.

The calculation of the optimal quantity of energy to sell in each settlement period can be effected in a similar fashion. In its most abstract and simplistic functional form, the engine takes the following inputs for every settlement period:
Reward Probability pairings: where S is the total number of pairings and s is the index
Penalty Probability pairings: where R is the total number of pairings and r is the index

Output value of wind: where Q is the maximum output of the wind farm and q is the index. The index q equates to the output level of the wind farm, which if nominated as firm energy would expect to receive EARU (Expected Additional Revenue Unconstrained)

Using these values it is possible to estimate the Expected Additional Revenue Unconstrained (EARU) for each index value, q.

The engine then produces a suggested firm sales amount as an output for the period.

While the processing engine provides for a high degree of automation using direct feeds and call routines implemented using a combination of hardware and software utilities, it is useful to provide a user interface to the system. Such an interface, within the simplification of the architecture presented in FIG. 4 may allow be via the trading decision module 415 and allows the user, the trader, an opportunity for the trader to overtype the forecasts if he/she feels it is not accurate, the facility to operate or run the optimizer, and then an opportunity for the trader to overtype the resulting suggested firm sales amount. Once the firm sales amount is acceptable to the trader it is then possible for the trader to commit that nomination for subsequent submission to the third party purchasers of the energy from the wind farm. Alternatively, or in addition, the value may be used internally for further calculations such as shortfall amounts that need to be compensated through a sourcing from other parties.

Where the possibility of more than one trade for the same settlement period is provided, it will be understood that although there is a possibility to thereby revisit the net contract volume before the actual provision of the energy such further trades will only be worthwhile if they contribute a greater positive change in EARU than the cost of the trading action.

The set of EARUq points for each q will look something like FIG. 5. Each of the values of EARUq found above may then be used in the following steps.
1. It will be understood that post the calculation of the EARUq set for the settlement period we have an array of EARUq values, where q denotes the possible MWh outputs of the farm.
2. Determine what the suggested firm sales amount (NO) should be. This involves adjusting the contract position if there is already a position to account for the cost of moving the position versus the cost of not changing:
   a. If it is the first sales opportunity sell at the maximum EARUq point as being the firm point NO.
      i. NO=value of q which results in Max(EARUq)
      ii. NF=NO must be saved for future calculations (all net contract positions should be stored)
   b. If a non-zero net contract position exists for the period, the generation forecast from that earlier trade may have been different resulting in NF not coinciding with the maximum point on the new EARU curve:
      i. In order to sell the optimum firm volume it is possible to assess the benefits of adjusting the position via further sales/purchases versus the detrimental effects of staying with the current net contract position.
      ii. The likely revenue resultant from maintaining the current net contract position NF may be assessed. This is determined by creating an EARU curve incorporating the latest forecast information. Call the difference between this figure and Max(EARUq) the Estimated Cost of Inaction (ECI).
      iii. If the prices available in the marketplace for altering the net contract position towards Max(EARUq) by sales or purchases permit that trading action to be accomplished more cheaply than the estimated consequences of not performing the action (as expressed by ECI) then the further trade should be performed.
   c. Suggested firm sales amounts are stored in a table and displayed to the user, ready for the user to commit these for submission.

It will be understood that what has been described here are exemplary embodiments of a methodology and architecture that may be used to optimize the firmly sold contribution of energy from a renewable generation asset to a power grid. While the teaching has been explained with reference to a single wind farm it will be understood that such is for the ease of understanding and the term wind farm will be understood as any number of gensets be there geographically co-located or otherwise. By defining the optimum nominated contribution it is possible to efficiently and confidently determine how the contribution by such renewable energy resources can be maximized.

The words comprises/comprising when used in this specification are to specify the presence of stated features, integers, steps or components but does not preclude the presence or addition of one or more other features, integers , steps, components or groups thereof.

It should also be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

1. A computer implemented method for determining an optimal firm sales volume for power provided by a renewable energy generation site into a power grid arrangement within a designated time period, the method including:
1. Providing a generation output forecast for the renewable energy generation site in the form of at least one distribution forecast,
b. Providing a market forecast in the form of at least one distribution forecast,
c. Combining each of the market and wind distribution forecasts to provide an array of possible earnings per energy output from the renewable energy generation site,
d. Determining from within the array, an appropriate proportion of energy output to sell for maximizing the earnings within that settlement period, and providing that proportion of energy output value as an output value for contribution by the renewable energy generation site into the power grid.

2. The method of claim 1 wherein the renewable energy generation site includes a plurality of geographically separated renewable energy generation sites, the method including combining generation output forecasts for each of the plurality of generation sites.

3. The method of claim 1 wherein the renewable energy generation site is a wind farm.

4. The method of claim 1 wherein the renewable energy generation site provides a stochastic output.

5. The method of claim 1 wherein the generation output forecast is provided by inputting live data from at least one geographic location into a model of output behavior for that geographic location.

6. The method of claim 5 wherein the output of the forecast may be constrained using one or more parameters related to performance of the renewable generation site prior to generating the distribution forecast.

7. The method of claim 1 wherein the market price forecast includes one or more prices.

8. The method of claim 7 wherein the one or more prices are provided as probability density functions.

9. The method of claim 8 wherein the probability density functions include a plurality of probability pairs,

10. The method of claim 9 wherein the plurality of probability pairs are utilized to provide forecasts of market prices, spill prices and penalty prices.

11. The method of claim 1 wherein the appropriate energy output is determined by maximizing a function representative of earnings achieved per nominated energy output versus earnings lost by missing that nomination.

12. A computer system configured to provide as an output an estimate of the optimal quantity of energy generated by a renewable energy generation site that should be sold firm for a plurality of intervals within a nominated time period, the system including:
a. A datastore having a plurality of data feeds;
i. A first feed coupled to a renewable energy generation site and configured to receive data pertaining to climatic conditions at that renewable energy generation site,
ii. A second feed coupled to a renewable energy generation site forecast engine, the renewable energy generation site forecast engine configured to receive from the datastore date from the first feed and provide as an output to the datastore a forecast distribution for estimated power output from the renewable energy generation site for specific intervals within a nominated time period,
iii. A third feed coupled to a market forecast engine, the market forecast engine configured to provide as an output to the datastore a forecast distribution for estimated prices within the power grid,
b. An optimization engine coupled to the data store and configured to use data from each of the first, second and third data feeds to:
i. Combine the data from the second and third feeds to provide an array of values for each interval, the array providing a relationship between power output sold from the renewable energy generation site and expected net earnings,
ii. Assess the array of value to determine an optimal value of power output for that time period for a specific set of conditions, and
iii. Output that optimal value as an output from the wind farm to the power grid for that interval.

13. The system of claim 12 wherein the renewable energy generation site is a wind farm.

14. The system of claim 12 wherein the renewable energy generation site is representative of plurality of geographically separated renewable energy generation sites.

15. A computer implemented method to optimize the firmly sold contribution of energy from a renewable generation asset to a power grid, the method including the combining each of market and wind distribution forecasts to provide an array of possible earnings per energy output from the renewable energy generation site, and determining from within the array, an appropriate proportion of energy output to sell for maximizing the earnings within that settlement period, and providing that proportion of energy output value as an output value for contribution by the renewable energy generation site into the power grid.

16. The method of claim 15 wherein the forecasts are provided in the form of a distribution forecast.

17. Method and system for controlling the contribution of renewal energy to a power grid.
